(19) United States
(12) Patent Application Publication
(10) Pub. No.: US 2009/0094839 A1
(43) Pub. Date: Apr. 16, 2009

(54) Electronic Utility Knife with Safety Reaction System

(76) Inventor: Earl Votolato, Newport Beach, CA (US)

Correspondence Address: FISH & ASSOCIATES, PC;ROBERT D. FISH, 2603 Main Street, Suite 1000, Irvine, CA, 92614-6232, US

(21) Appl. No.: 11/871,048

(22) Filed: Oct. 11, 2007

(51) Int. Cl. B26B 1/08

(52) U.S. Cl. 30/162

(57) ABSTRACT

A hand-operated electronic utility knife includes electronics that utilize sensors to detect an unsafe condition, and a reaction system that automatically protects the user or another from the exposed blade upon detection of an unsafe condition. Preferred sensors typically include contact detection sensors, electromagnetic field sensors, Hall Effect sensors, infrared sensors, and sensors that utilize lasers to detect an unsafe condition. Reaction systems can include any suitable electromechanical and/or mechanical system capable of retracting the blade to a protected and safe condition, or covering the blade with a sheath or other protective blade covering.

### FIELD OF THE INVENTION

The field of the invention is utility knives.

### BACKGROUND

Utility knives typically have a blade that either: (a) extends externally from a housing in a fixed position; or (b) is stored internally in the housing until the blade is manually extended. Improvements have been made to include a variety of different mechanisms to retract or extend the blade mainly for safety reasons. For example, new designs of utility knives typically have a blade that can either be manually extended out of the housing to an operating position or manually pressing a protective blade guard back and away from a blade that is in a fixed extended position out of the housing. However, the knives in these instances often still require the user to manually retract the blade or slide the protective blade guard back onto the blade after use. In addition, the protective guards do not lock over the blades after the knife has been operated which results in the blade being in an unprotected state. In all these cases, problems arise when the blade is in an extended unprotected position where it can cause accidentally injury to the user or persons in close proximity to the user.

The problem of accidental injury has been long recognized, with numerous solutions being put forward at various times. U.S. Pat. No. 4,980,977 to Matin et al. (January 1991) and U.S. Pat. No. 5,878,501 to Owens et al. (March 1999), for example, teach utility knives that have manual safety guards that automatically lock and guard the blade when not in use, but which leaves the blade in an extended unprotected position for multiple uses.

More recently the present inventor pioneered utility knives having a mechanism that automatically re-locks the protective blade guard to prevent more than a single use of the blade. (See e.g., application Ser. No. 09/804,451, published in September 2002 as 2003/0131393, application Ser. No. 10/300,382, published in May 2004 as 2004/0093734, and U.S. application Ser. No. 11/621,208).

Unfortunately, there are still no mechanisms that can automatically protect a user or others from accidental injury where the knife blade remains in an extended unprotected position.

It is known to use detection systems to automatically protect a user during operation of machinery, and in particular during a given aspect of operation of the machine (e.g., hand guards on presses, sewing machines, and cutting machinery, such as table saws, miter saws, circular saws, and planers). For example, U.S. Pat. No. 6,903,327 to Appleyard teaches a system that automatically stops or prevents the movement of a press when the user intersects a laser beam field. U.S. Pat. No. 7,225,712, and U.S. Pat. No. 7,231,856 to Gass et al., teaches a woodworking machine that is capable of detecting an unsafe condition and preventing the cutting portion of the machine from spinning upon the occurrence of a specified event. (See also, U.S. Pat. No. 3,829,850 to Guetersloh, U.S. Pat. No. 3,947,734 to Fyler, U.S. Pat. No. 4,060,160 to Lieber, and U.S. Pat. No. 5,081,406 to Hughes. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply).

However, the detection systems of the above examples are all operable on electrically powered machinery. No one has ever contemplated applying such safety systems to simple devices such as utility knives that are (or at least previously have been) entirely hand powered. Thus, among other things, there is still a need for an electronic utility knife that is capable of detecting an unsafe condition when the knife blade is in an unprotected position in order to automatically protect a user or others from accidental injury.

### SUMMARY OF THE INVENTION

The present invention provides apparatus, systems and methods in which a electronic utility knife that can be hand-operated by a user generally comprises a housing, a utility knife blade, a power supply, electronics that utilize sensors to detect an unsafe condition, and a reaction system that automatically protects the user or another from the exposed blade upon detection of an unsafe condition.

In most preferred embodiments, structurally the electronic utility knife with safety reaction system is substantially as shown and described in U.S. application Ser. No. 11/621,208, which is incorporated by reference herein.

Preferred sensors typically include contact detection sensors, electromagnetic field sensors, Hall Effect sensors, infrared sensors, and sensors that utilize lasers to detect an unsafe condition. It is contemplated that any suitable number of sensors can be utilized, and such sensors can be positioned internally or externally in any suitable configuration.

Preferred electronics utilize the sensors to detect an unsafe condition and cooperate with the reaction system to trigger a response that protects the user or another from the exposed blade when an unsafe condition is detected by sensors.

Preferred reaction system is a solenoid, or other suitable electromechanical and/or mechanical system capable of retracting the blade to a protected and safe condition, or covering the blade with a sheath or other protective blade covering.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1A is a cross sectional view of an electronic utility knife having a safety reaction system and a blade in an exposed position.

FIG. 1B is a cross sectional view of the electronic utility knife of FIG. 1A having a safety reaction system and a blade in a retracted and safe position.

FIG. 2A is a cross sectional view of an alternate embodiment of an electronic utility knife having a safety reaction system with a blade in a fixed extended position and a protective blade guard in an open position.

FIG. 2B is a cross sectional view of the alternate embodiment of the electronic utility knife of FIG. 2A, in which the protective blade guard is in a closed position.

### DETAILED DESCRIPTION

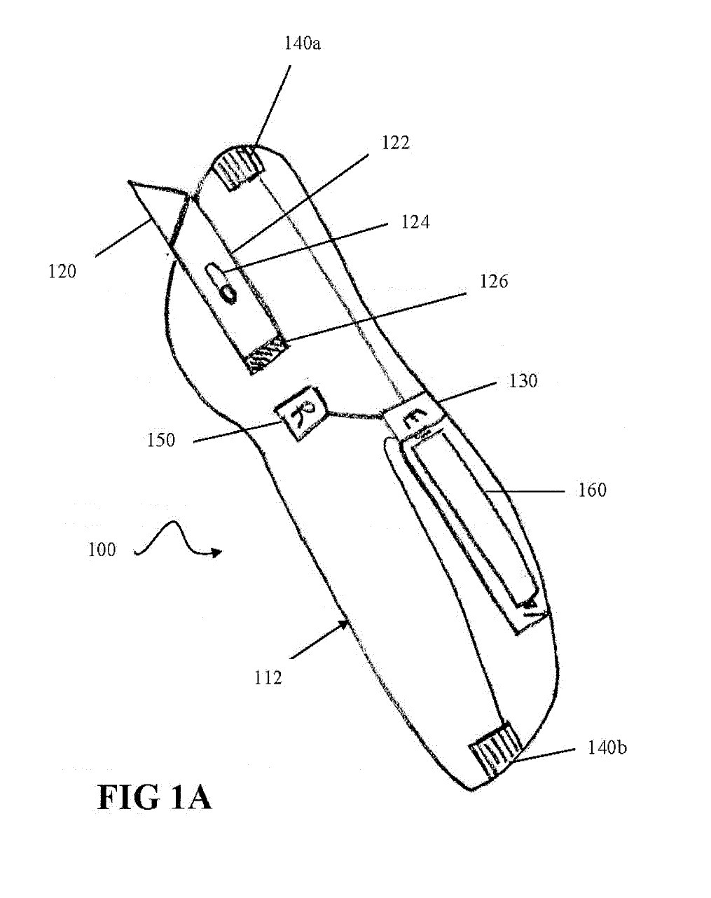

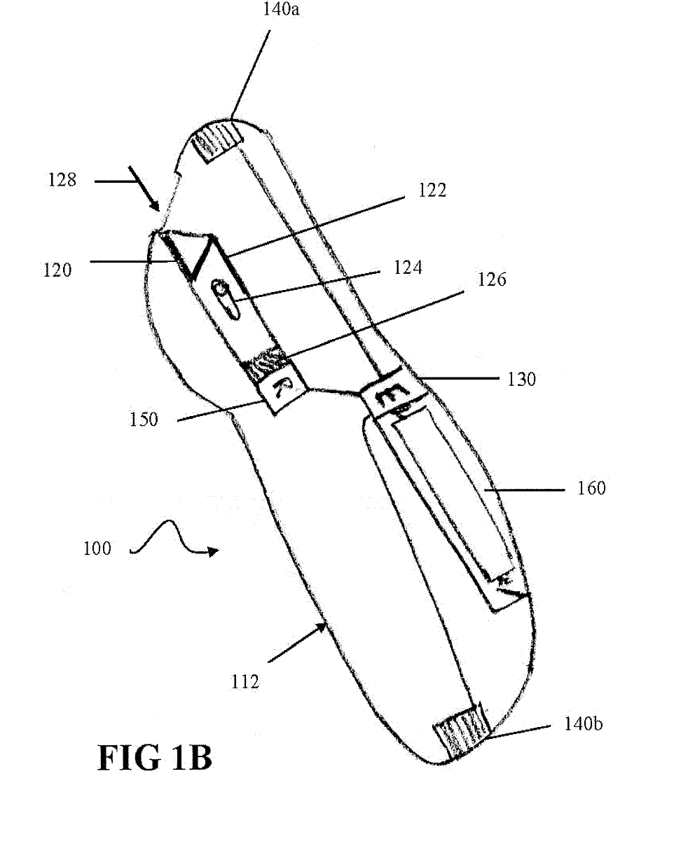

FIG. 1A generally depicts an electronic utility knife 100 having a housing 112, utility knife blade 120, blade holder 122, power supply 160, electronics 130 that utilize sensors 140a, 140b to detect an unsafe condition, and reaction system 150 that automatically protects the user or another from the exposed blade upon detection of an unsafe condition.

It is contemplated that the unsafe condition typically includes (a) a “body part” in contact with an exposed part of the blade, (b) a “very close proximity” of a body part to an exposed part of the blade, (c) a wire in “close proximity” to the exposed part of the blade, and (d) all other conditions that are unsafe to the user or another.

As used herein, the term “body part” should be interpreted broadly to mean the fingers, hands, arms, legs, feet, eyes, face, torso and other parts of a human being capable of being cut by a utility knife blade. Thus, all portions of the user's body and another human being capable of being cut are considered body parts.

As used herein, the term “very close proximity” should be interpreted as applied to a utility knife with a safety reaction system to include all situations where the exposed unprotected portion of the utility knife blade is within 0.5 inches of a body part other than a user's hand in the normal operating configuration of the utility knife.

As used herein, the term “close proximity” should be interpreted as applied to a utility knife with a safety reaction system to include all situations where the exposed unprotected portion of the utility knife blade is within 4 inches of a wire.

Housing 112 is preferably sized and dimensioned to fit comfortably in the hand of a user. Housing 112 can be made of any suitable material, including metals, alloys, and plastics, and can have a hollowed out section (not shown) for storing spare blades. Housing 112 is preferably ambidextrous, but alternatively can include contours that would tend to make the device more acceptable to right or left handed use.

Power supply 160 can be any suitable power source. In especially preferred embodiments power supply 160 can be a DC power source, a solar cell, a rechargeable power supply, or a connector to an AC power source. Power source 160 provides power for use by electronics 130, sensors 140a, 140b, and reaction system 150.

Preferred electronics 130 utilize sensors 140a, 140b to detect an unsafe condition. Electronics 130 cooperate with reaction system 150 to trigger a response that protects the user or another from the exposed blade when an unsafe condition is detected by sensors 140a, 140b.

In most preferred embodiments, sensors 140a, 140b typically include contact detection sensors, electromagnetic field sensors, Hall Effect sensors, infrared sensors, and sensors that utilize lasers to detect an unsafe condition via mechanisms well known in the art. For illustrative purposes only, sensor 140a is positioned at the cutting end and sensor 140b is positioned as the butt end of utility knife 100. However, it is contemplated that any suitable number of sensors can be utilized, and such sensors can be positioned internally or externally in any suitable configuration.

FIG. 1B is a cross sectional view of the electronic utility knife with safety reaction system with the blade in a retracted and safe position. It is contemplated that upon detection of an unsafe condition via sensors 140a, 140b, electronics 130 trigger reaction system 150 to retract blade 120 back into housing 112 as shown by arrow 128.

Preferred reaction system 150 is a solenoid, or other suitable electromechanical and or mechanical system capable of retracting blade 120 to a protected and safe condition, or covering the blade with a sheath or other blade protective covering. For example, upon detection of an unsafe condition electronics 130 trigger reaction system 150 to become magnetized by allowing a current to flow to the solenoid from power supply 160, thus attracting magnetic region 126 of blade assembly 122 to retract blade 120 along slider 124 into utility knife 100.

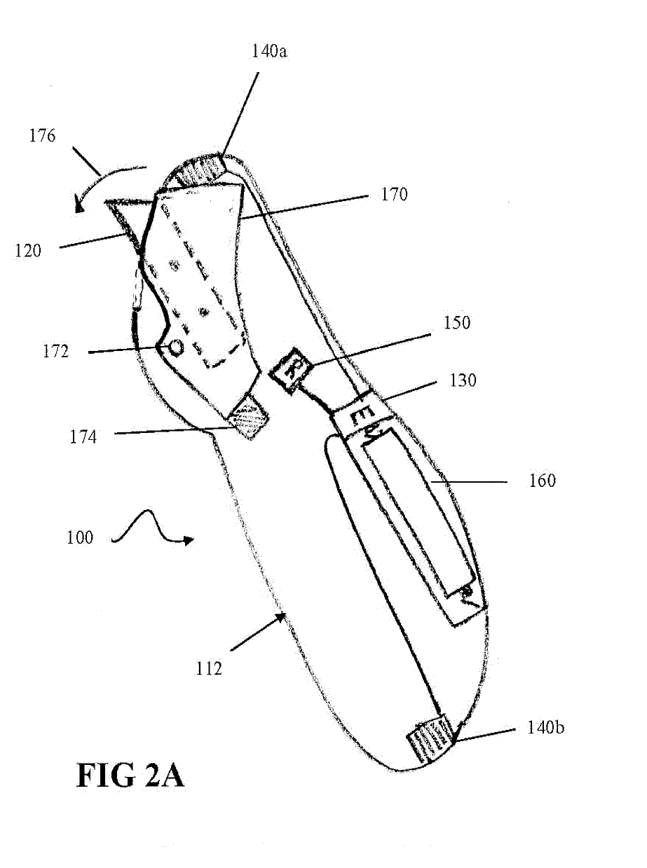

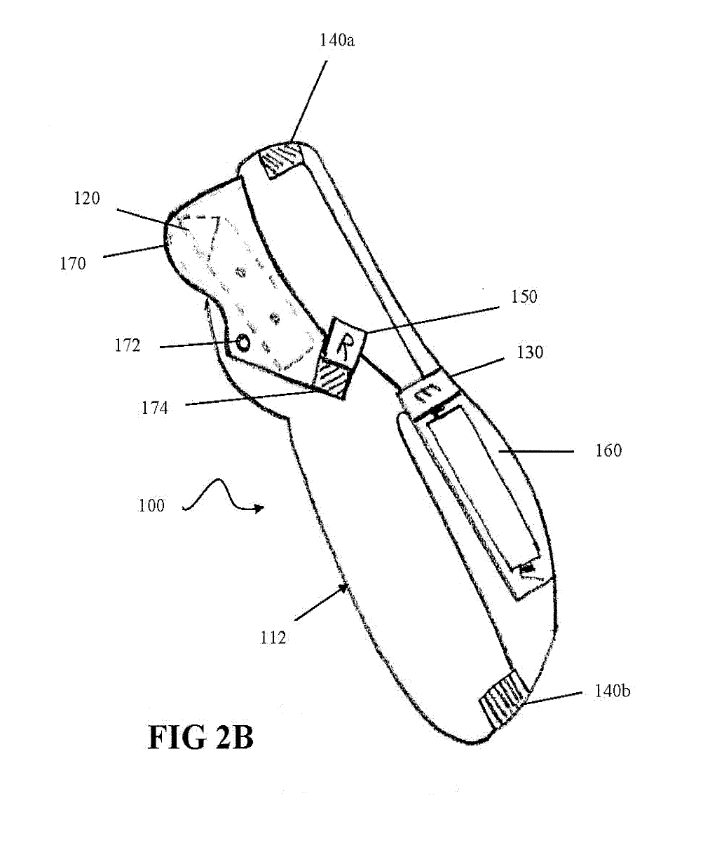

In an alternative embodiment shown in FIGS. 2A-2B, a utility knife 100A is similar to that of FIGS. 1A-1B except that there is a protective blade guard 170 having a magnetic region 174 and blade guard pivot 172. As shown in FIG. 2A by arrow 176, upon detection of an unsafe condition electronics 130 trigger reaction system 150 to initiate protective blade guard 170 to snap closed covering blade 120 via reaction system 150 becoming magnetized.

Thus, specific embodiments and applications of an electronic utility knife with safety reaction system have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A utility knife that can be hand-operated by a user, comprising:
a housing;
a utility knife blade; and
electronics that detects an unsafe condition and triggers a response that protects the user from the blade.

2. The utility knife of claim 1, wherein the unsafe condition comprises a body part in contact with an exposed part of the blade.

3. The utility knife of claim 1, wherein the unsafe condition comprises a very close proximity of a body part to an exposed part of the blade.

4. The utility knife of claim 1, wherein the unsafe condition comprises a wire in close proximity to an exposed part of the blade.

5. The utility knife of claim 1, wherein the electronics utilizes a Hall Effect sensor to detect the unsafe condition.

6. The utility knife of claim 1, wherein the electronics utilizes a laser detection system to detect the unsafe condition.

7. The utility knife of claim 1, wherein the electronics utilizes an infrared detection system to detect the unsafe condition.

8. The utility knife of claim 1, wherein the response further comprising a reaction system that cooperates with the electronics to retract the blade back into the housing.

9. The utility knife of claim 1, wherein the response further comprising the reaction system that cooperates with the electronics to deploy a blade guard form the housing.

10. The utility knife of claim 1, further comprising a DC power source for the electronics.

11. The utility knife of claim 1, further comprising a solar cell that provides power for use by the electronics.

12. The utility knife of claim 1, further comprising a rechargeable power supply configured to provide power to the electronics.

13. The utility knife of claim 12, further comprising a connector to an AC power source configured to provide power to the electronics.
